(19) United States
(12) Patent Application Publication
(10) Pub. No.: US 2026/0269134 A1
(43) Pub. Date: Sep. 10, 2026

(54) MULTILAYER CERAMIC CAPACITOR

(71) Applicant: Murata Manufacturing Co., Ltd., Nagaokakyo-shi (JP)

(72) Inventor: Yukito NISHIMURA, Nagaokakyo-shi (JP)

(73) Assignee: Murata Manufacturing Co., Ltd., Nagaokakyo-shi (JP)

(21) Appl. No.: 19/551,653

(22) Filed: Feb. 27, 2026

(30) Foreign Application Priority Data
Mar. 10, 2025 (JP) 2025-037313

(51) Int. Cl. H01G 4/30; H01G 4/012

(52) U.S. Cl. CPC H01G 4/30; H01G 4/012

(57) ABSTRACT

A multilayer ceramic capacitor includes a ceramic body having dielectric layers and inner electrode layers laminated in a lamination direction. The ceramic body includes a facing portion in which adjacent inner electrode layers face each other in the lamination direction and an extending portion in which the inner electrode layers extend to an end face of the ceramic body to connect to an outer electrode. A shift width between width-direction end portions of the inner electrode layers is 0.5 μm or less. A continuity of portions the inner electrode layers in the extending portion is higher than a continuity of the inner electrode layers in the facing portion.

### CROSS-REFERENCE TO RELATED APPLICATION

This application is based upon and claims the benefit of priority from Japanese Patent Application No. 2025-037313, filed on Mar. 10, 2025, the entire contents of which are incorporated herein by reference.

### BACKGROUND

### 1. Field

The present disclosure relates to a multilayer ceramic capacitor.

### 2. Description of the Related Art

A multilayer ceramic capacitor that is based on the related art is described in Japanese Unexamined Patent Application Publication No. 2021-20845. This multilayer ceramic capacitor includes a ceramic body including dielectric layers and inner electrodes. Outer electrodes are disposed outside the ceramic body. The outer electrodes are electrically connected to the inner electrodes.

### SUMMARY

A multilayer ceramic capacitor according to the present disclosure includes a body portion including a multilayer body. The multilayer body includes a plurality of dielectric layers and a plurality of inner electrode layers that are laminated together. The body portion has a first main surface and a second main surface that face away from each other in a lamination direction, a first side surface and a second side surface that face away from each other in a width direction orthogonal to the lamination direction, and a first end face and a second end face that face away from each other in a length direction orthogonal to the lamination direction and the width direction. An outer electrode electrically connected to at least one of the plurality of inner electrode layers is disposed so as to cover at least a portion of the first end face and at least a portion of the second end face. The shift widths as viewed in the lamination direction between end portions in the width direction of the plurality of inner electrode layers are 0.5 μm or less. The body portion includes a facing portion in which inner electrode layers adjacent to each other in the lamination direction of the plurality of inner electrode layers face each other, and an extending portion in which portions of the plurality of inner electrode layers extend to the first end face or the second end face.

When any section in one of the plurality of inner electrode layers is a target section, and a value obtained by dividing, by a length of the target section, a sum of lengths of portions of the section in which the material of the inner electrode layers is truly present in the target section when the target section is viewed microscopically is assumed to be continuity of the target section, continuity of portions of the plurality of inner electrode layers that are present in the extending portion is higher than continuity of portions of the plurality of inner electrode layers that are present in the facing portion.

### BRIEF DESCRIPTION OF THE DRAWINGS

FIG. 1 is a perspective view of a multilayer ceramic capacitor according to a first embodiment;

FIG. 2 is a perspective view of a body portion included in the multilayer ceramic capacitor according to the first embodiment;

FIG. 3 is an exploded perspective view of a body portion of the multilayer ceramic capacitor according to the first embodiment;

FIG. 4 is a cross-sectional view as viewed along arrows IV-IV in FIG. 1;

FIG. 5 is a cross-sectional view as viewed along arrows V-V in FIG. 1;

FIG. 6 is a cross-sectional view of the multilayer ceramic capacitor according to the first embodiment;

FIG. 7 is an enlarged view of the portion illustrated in the center of FIG. 6;

FIG. 8 is an enlarged cross-sectional view of a first outer electrode and the vicinity thereof in FIG. 6;

FIG. 9 is a diagram in which cross-sectional lines have been added to the cross-sectional view of the multilayer ceramic capacitor according to the first embodiment;

FIG. 10 is a cross-sectional view as viewed along arrows X-X in FIG. 9; and

FIG. 11 is a cross-sectional view as viewed along arrows XI-XI in FIG. 9.

### DETAILED DESCRIPTION

The dimensional ratios illustrated in the drawings do not necessarily represent actual ones faithfully and may be exaggerated for the convenience of description. In the following description, references to upper or lower concept do not necessarily mean absolute upper or lower concept and may mean relative upper or lower concept in the illustrated posture.

In the connection between the inner electrodes and the outer electrodes, higher connectivity reduces equivalent series resistance and improves characteristics as a capacitor. Increase in continuity of the inner electrodes is effective to improve the connectivity between the inner electrodes and the outer electrodes.

Accordingly, the present disclosure is directed to providing a multilayer ceramic capacitor in which interlayer peeling is less likely to occur between the inner electrodes and the dielectric layers.

### First Embodiment

### Structure

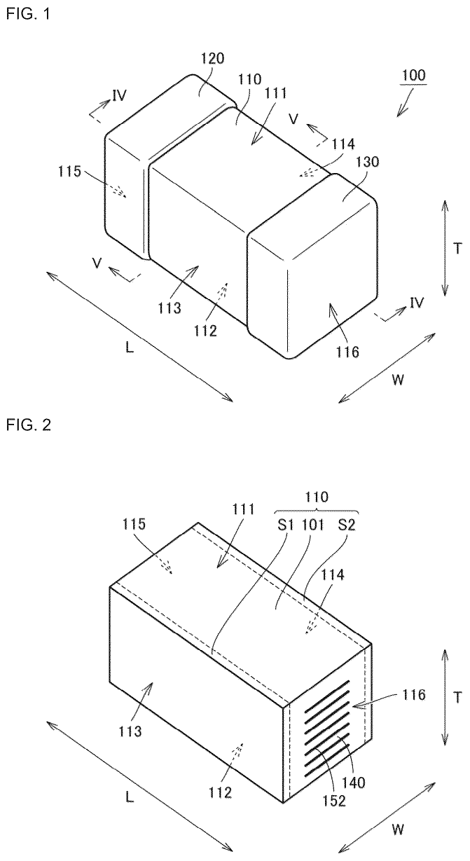

A multilayer ceramic capacitor according to a first embodiment of the present disclosure will be described with reference to FIGS. 1 to 5.

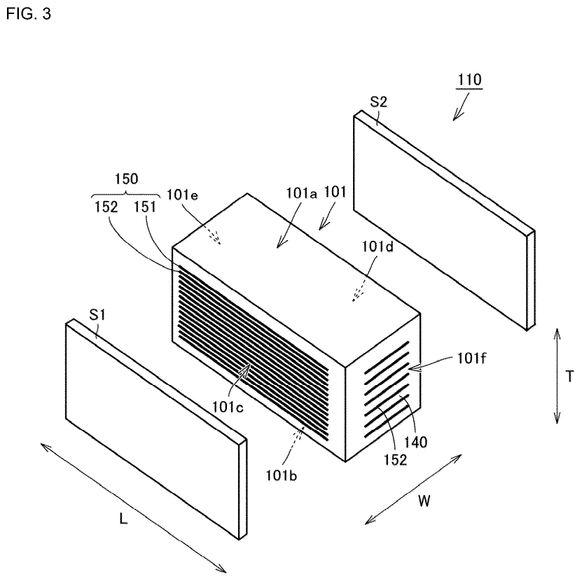

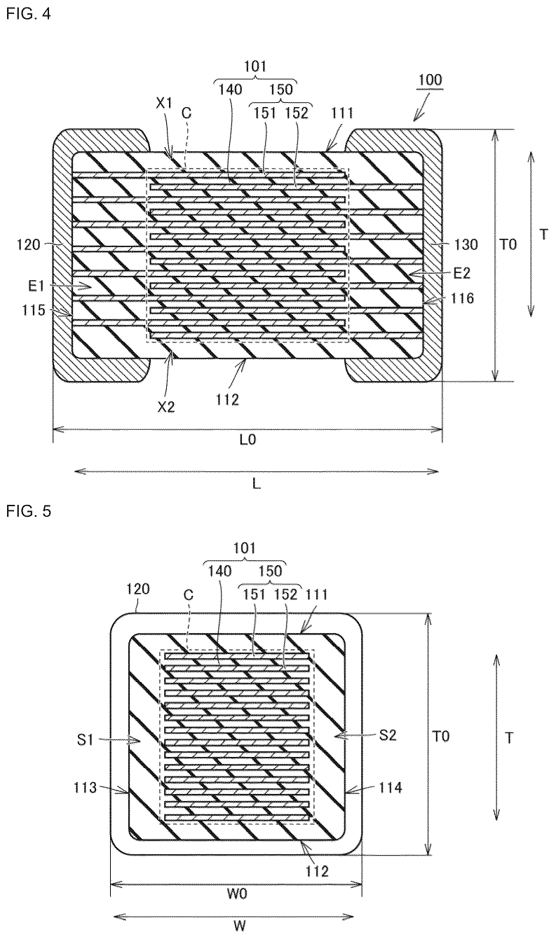

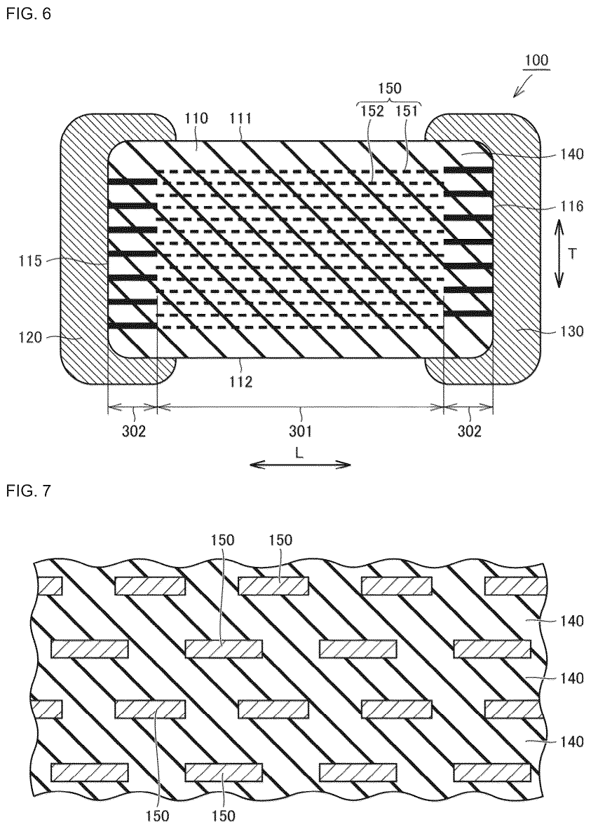

The appearance of a multilayer ceramic capacitor 100 according to the embodiment will be illustrated in FIG. 1. A body portion 110, which is a portion of the multilayer ceramic capacitor 100, is illustrated in FIG. 2. An exploded perspective view for schematically describing the structure of the body portion 110 is illustrated in FIG. 3. A cross-sectional view as viewed along arrows IV-IV in FIG. 1 is illustrated in FIG. 4. A cross-sectional view as viewed along arrows V-V in FIG. 1 is illustrated in FIG. 5.

As illustrated in FIG. 1, the multilayer ceramic capacitor 100 includes the body portion 110 and outer electrodes. The multilayer ceramic capacitor 100 includes a first outer electrode 120 and a second outer electrode 130 as the outer electrodes.

As illustrated in FIG. 1, the body portion 110 has a substantially rectangular parallelepiped shape. As illustrated in FIGS. 1 and 2, the body portion 110 has a first main surface 111 and a second main surface 112 that face away from each other in a thickness direction T (also referred to as a lamination direction), a first side surface 113 and a second side surface 114 that face away from each other in a width direction W that intersects the thickness direction T, and a first end face 115 and a second end face 116 that face away from each other in a length direction L that intersects the thickness direction T and the width direction W.

The corner portions and the ridge portions of the body portion 110 may be rounded. Here, three surfaces of the body portion 110 intersect at each of the corner portions, and two surfaces of the body portion 110 intersect at each of the ridge portions.

As illustrated in FIGS. 1 and 4, the first outer electrode 120 is provided on the first end face 115. Specifically, the first outer electrode 120 is formed over the entire first end face 115 and formed to wrap around from the first end face 115 to the first main surface 111, the second main surface 112, the first side surface 113, and the second side surface 114.

As illustrated in FIGS. 1 and 4, the second outer electrode 130 is provided on the second end face 116. Specifically, the second outer electrode 130 is formed over the entire second end face 116 and formed to wrap around from the second end face 116 to the first main surface 111, the second main surface 112, the first side surface 113, and the second side surface 114.

As illustrated in FIGS. 2 and 3, the body portion 110 includes a multilayer body 101, a first side margin portion S1, and a second side margin portion S2.

As illustrated in FIG. 3, the multilayer body 101 has a pair of main surfaces 101a and 101b that face away from each other in the thickness direction T, a pair of side surfaces 101c and 101d that face away from each other in the width direction, and a pair of end faces 101e and 101f that face away from each other in the length direction. The pair of main surfaces 101a and 101b constitutes a portion of the first main surface 111 and a portion of the second main surface 112, respectively, of the body portion 110. The side surface 101c is covered with the first side margin portion S1, and the side surface 101d is covered with the second side margin portion S2. The pair of end faces 101e and 101f constitutes a portion of the first end face 115 and a portion of the second end face 116, respectively, of the body portion 110.

As illustrated in FIGS. 3 to 5, the multilayer body 101 includes a plurality of dielectric layers 140 and a plurality of inner electrode layers 150 that are alternately laminated together in the thickness direction T. The plurality of inner electrode layers 150 include a plurality of first inner electrode layers 151 and a plurality of second inner electrode layers 152. The plurality of first inner electrode layers 151 and the plurality of second inner electrode layers 152 are alternately laminated together in the thickness direction T.

The plurality of first inner electrode layers 151 are extended to the first end face 115. The plurality of first inner electrode layers 151 are connected to the first outer electrode 120. The plurality of second inner electrode layers 152 are extended to the second end face 116. The plurality of second inner electrode layers 152 are connected to the second outer electrode 130. Both end portions in the width direction W of the plurality of first inner electrode layers 151 and the plurality of second inner electrode layers 152 are exposed at the side surfaces 101c and 101d.

It should be noted that FIGS. 3 to 5 illustrate an example in which seven first inner electrode layers 151 and seven second inner electrode layers 152 are provided, but the number of first inner electrode layers 151 and the number of second inner electrode layers 152 are not limited to seven.

The plurality of dielectric layers 140 include outer dielectric layers located between the inner electrode layer 150 closest to the first main surface 111 in the thickness direction T and the first main surface 111 and located between the inner electrode layer 150 closest to the second main surface 112 in the thickness direction T and the second main surface 112 and inner dielectric layers located between the inner electrode layers 150 adjacent to each other in the thickness direction T.

The number of the plurality of dielectric layers 140 may be 85 or more and 650 or less. The plurality of dielectric layers 140 are each made of a dielectric ceramic material including one of components such as, for example, BaTiO₃, CaTiO₃, SrTiO₃, and CaZrO₃. Components less than the main component may be added to the dielectric layers 140. The components to be added may be, for example, Mn compounds, Fe compounds, Cr compounds, Co compounds, or Ni compounds. The thickness of each of the dielectric layers may be 0.53 μm or more and 1.1 μm or less.

The first inner electrode layer 151 and the second inner electrode layer 152 each contain Ni as a main component. The first inner electrode layer 151 and the second inner electrode layer 152 may further contain a dielectric material of the same composition system as the ceramic contained in the dielectric layer 140. In addition, the first inner electrode layer 151 and the second inner electrode layer 152 may contain Sn or the like at the interfaces with the dielectric layer 140.

As illustrated in FIG. 4, the multilayer body 101 is divided into an inner layer portion C, a first outer layer portion X1, a second outer layer portion X2, a first end margin portion E1, and a second end margin portion E2. The inner layer portion C has an electrostatic capacity because portions of the first inner electrode layers 151 and portions of the second inner electrode layers 152 are laminated together in the thickness direction T.

The first outer layer portion X1 and the second outer layer portion X2 sandwich the inner layer portion C in the thickness direction T. The first outer layer portion X1 is located outside the inner layer portion C in the thickness direction T and is located closer to the first main surface 111. The second outer layer portion X2 is located outside the inner layer portion C in the thickness direction T and is located closer to the second main surface 112.

The first outer layer portion X1 and the second outer layer portion X2 constitute the outer dielectric layers. The first outer layer portion X1 and the second outer layer portion X2 may be made of the same dielectric ceramic material as the plurality of dielectric layers 140 or may be made of a different dielectric ceramic material from the plurality of dielectric layers 140.

The first end margin portion E1 and the second end margin portion E2 sandwich the inner layer portion C in the length direction L. The first end margin portion E1 is located outside the inner layer portion C in the length direction L and is located closer to the first end face 115. The second end margin portion E2 is located outside the inner layer portion C in the length direction L and is located closer to the second end face 116.

In the body portion 110, the side margin portions are located between the first side surface 113 and the plurality of inner electrode layers 150 and between the second side surface 114 and the plurality of inner electrode layers 150 in the width direction W. The side margin portions include the first side margin portion S1 and the second side margin portion S2.

The first side margin portion S1 is provided on the side surface 101c of the multilayer body 101. The first side margin portion S1 is provided to entirely cover the side surface 101c. The first side margin portion S1 is present from one end of the inner electrode layer 150 located on one side in the width direction W to the first side surface 113 in the body portion 110.

The second side margin portion S2 is provided on the side surface 101d of the multilayer body 101. The second side margin portion S2 is provided to entirely cover the side surface 101d. The second side margin portion S2 is present from the other end of the inner electrode layer 150 located on the other side in the width direction W to the second side surface 114 in the body portion 110.

The first side margin portion S1 and the second side margin portion S2 may be made of the same dielectric ceramic material as the plurality of dielectric layers 140 or may be made of a different dielectric ceramic material from the plurality of dielectric layers 140.

Si is segregated in the first side margin portion S1 and the second side margin portion S2. The segregation of Si can be confirmed, for example, by observing the cross-section with a SEM/EDX.

Each of the first side margin portion S1 and the second side margin portion S2 may include a plurality of layers. In the plurality of layers, interfaces between layers do not necessarily need to be observed.

As described above, the size of the multilayer ceramic capacitor 100 that includes the body portion 110, the first outer electrode 120, and the second outer electrode 130 is not particularly limited but can have, for example, the following range.

As illustrated in FIG. 4, the dimension (length dimension L0) in the length direction L of the multilayer ceramic capacitor 100 is, for example, 0.4 mm or more and 1.2 mm or less. The dimension (thickness dimension T0) in the thickness direction T of the multilayer ceramic capacitor 100 is, for example, 0.2 mm or more and 0.8 mm or less. As illustrated in FIG. 5, the dimension (width dimension W0) in the width direction W of the multilayer ceramic capacitor 100 is, for example, 0.2 mm or more and 0.7 mm or less. It should be noted that the dimensions indicated here are values excluding the dimension tolerances. In practice, the dimension tolerances are added to the dimensions indicated here.

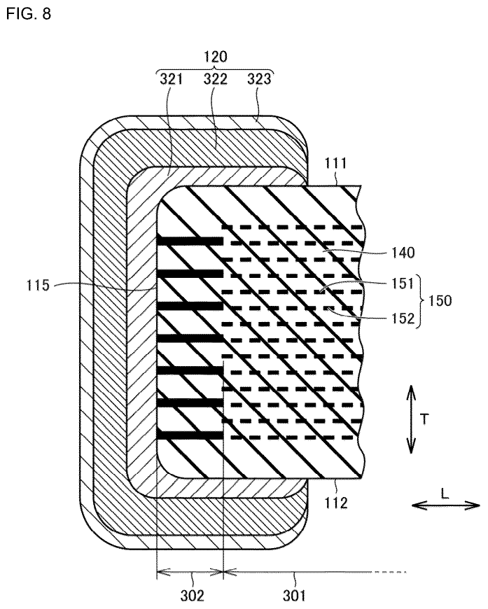

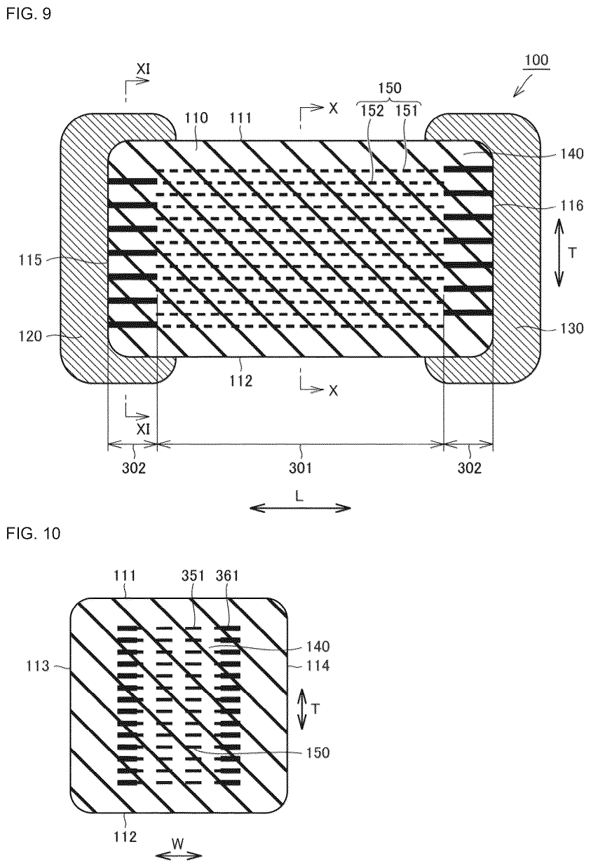

A cross-sectional view of the multilayer ceramic capacitor 100 is illustrated in FIG. 6. The inner electrode layers 150 are a single layered conductor macroscopically but, microscopically, are not completely continuous layers that are covered entirely, and many fine opening portions are present halfway. In consideration of this, the inner electrode layers 150 are partially indicated by dashed lines in FIG. 6. The fine opening portions of the inner electrode layer 150 may be present irregularly in practice, but the opening portions are schematically illustrated as dashed lines in FIG. 6. The portion of the inner electrode layers 150 indicated by dashed lines in the center of FIG. 6 is partially illustrated in FIG. 7 in an enlarged manner. An enlarged cross-sectional view of the first outer electrode 120 and the vicinity thereof in FIG. 6 is illustrated in FIG. 8.

The multilayer ceramic capacitor 100 according to the embodiment includes the body portion 110 including the multilayer body 101. The multilayer body 101 includes the plurality of dielectric layers 140 and the plurality of inner electrode layers 150 that are laminated together. The body portion 110 has the first main surface 111 and the second main surface 112 that face away from each other in the lamination direction, the first side surface 113 and the second side surface 114 that face away from each other in the width direction W orthogonal to the lamination direction, and the first end face 115 and the second end face 116 that face away from each other in the length direction L orthogonal to the lamination direction and the width direction W. The outer electrodes electrically connected to at least one of the plurality of inner electrode layers 150 are disposed so as to cover at least a portion of the first end face 115 and at least a portion of the second end face 116. The outer electrodes here are the first outer electrode 120 and the second outer electrode 130.

The shift widths as viewed in the lamination direction between the end portions in the width direction W of the plurality of inner electrode layers 150 are 0.5 μm or less.

The body portion 110 includes a facing portion 301 in which inner electrode layers 150 adjacent to each other in the lamination direction of the plurality of inner electrode layers 150 face each other, and an extending portion 302 in which portions of the plurality of inner electrode layers 150 extend to the first end face 115 or the second end face 116.

As used herein, “continuity” of a target section of an inner electrode layer 150 refers to a ratio of the actual presence of electrode material to the total length of that section. Specifically, continuity is defined as a value obtained by dividing the sum of the lengths of portions where the electrode material is present by the total length of the target section, as determined through microscopic observation. In the present disclosure, the continuity of the portions of the inner electrode layers 150 located in the extending portion 302 is configured to be higher than the continuity of the portions of the inner electrode layers 150 located in the facing portion 301.

### Outer Electrodes

The outer electrodes will be described in detail. The outer electrodes not only cover the end faces of the multilayer body 101 but also extend from the end faces to the side surfaces and the main surfaces. The outer electrode includes a base electrode layer and a plating layer disposed on the base electrode layer. The base electrode layer includes one or more selected from the group consisting of a baked layer, a resin layer, and a thin-film layer. The baked layer here contains glass and metal. The glass contained in the baked layer includes one or more elements selected from the group consisting of Si and homologous elements of Si. The metal contained in the baked layer includes at least one selected from, for example, Cu, Ni, Ag, Pd, Ag—Pd alloy, and Au. The baked layer may include a plurality of layers. In FIG. 8, a Cu layer 321 is illustrated as an example of the baked layer. The baked layer is formed by applying a conductive paste containing glass and metal onto the multilayer body 101 and baking the applied conductive paste. The baked layer may be fired simultaneously with the inner electrodes. The baked layer may also be baked after the inner electrodes are fired.

The resin layer here may contain conductive particles and a thermosetting resin. When the resin layer is formed as at least a portion of the base electrode layer, the resin layer may be formed directly on the surface of the multilayer body without the baked electrode layer being formed. The resin layer may also include a plurality of layers.

The thin-film layer here is a layer of deposited metal particles, with a thickness of 1 μm or less, that is formed by a thin-film formation method, such as sputtering or deposition.

The plating layer here contains at least one selected from the group consisting of, for example, Cu, Ni, Ag, Pd, Ag—Pd alloy, and Au. The plating layer may include a plurality of layers. The plating layer may have a two-layer structure that includes a Ni plating layer and a Sn plating layer. The Ni plating layer can prevent the base electrode layer from being eroded by solder used to mount ceramic electronic components. The Sn plating layer can improve the wettability of solder used to mount ceramic electronic components, thereby facilitating mounting. In FIG. 8, a Ni plating layer 322 and a Sn plating layer 323 are illustrated as an example.

### Inner Electrode Layer

The plurality of inner electrode layers 150 will be described in detail. The plurality of inner electrode layers 150 each include the first inner electrode layer 151 and the second inner electrode layer 152. The first inner electrode layer 151 is in contact with the first end face 115 and is not in contact with the second end face 116. The second inner electrode layer 152 is not in contact with the first end face 115 and is in contact with the second end face 116. The inner electrode layer 150 contains a metal such as, for example, Ni. The inner electrode layer 150 may further contain dielectric particles of the same composition system as the ceramic included in the dielectric layer. The number of the plurality of inner electrode layers 150 is may be 100 or more and 1000 or less. The thickness of the inner electrode layer 150 may be 0.4 μm or more and 0.45 μm or less. The first inner electrode layers 151 and the second inner electrode layers 152 are disposed such that an electrode facing portion in which the first inner electrode layers 151 and the second inner electrode layers 152 face each other and an electrode extending portion in which the inner electrode layers extend from the electrode facing portion to any one of the end faces of the multilayer body 101 are present. The electrode extending portion is present in each of the first end margin portion E1 and the second end margin portion E2. Sn or the like may be disposed on the interface between the inner electrode layer 150 and the dielectric layer. In FIG. 8, the facing portion 301 and the extending portion 302 are illustrated. The thickness of the inner electrode layers 150 in the extending portion 302 is greater than that in the facing portion 301. The thickness of the inner electrode layer 150 in the extending portion 302 may be at least 1.3 times and at most 1.6 times the thickness of the inner electrode layer 150 in the facing portion 301, i.e., a thickness ratio. As described above, to change the thickness of the inner electrode layer 150 depending on the section, double printing may be performed on the portion to be thickened during screen printing or gravure printing for forming the inner electrode layer 150. In another method, the portion to be thickened can be processed by increasing the thickness of a plate and the depth of the recess of the plate in advance.

### Continuity

The continuity of the inner electrode layers 150 may be measured using the following procedure. First, a cross-section of the electronic component is obtained by polishing the electronic component to a depth corresponding to approximately half of its dimension in the width direction W to expose a cross-section that includes the lamination direction and the length direction L. Next, a scanning electron microscope (SEM) is used to capture an image of the exposed cross-section, Within the captured image, a specific region of an inner electrode layer 150 is selected as a target section, e.g., ten inner electrode layers 150 in the extending portion, arranged at equal intervals in the lamination direction. Each of the ten extracted inner electrode layers 150 is microscopically observed, and the portions in which the material of the inner electrode layers 150 is truly present is identified from and the portions in which the material is not present in the target section. The continuity is defined as by measuring the lengths of the portions within the target section where the electrode material is actually present, summing these lengths, and dividing the resulting sum by the total length of the target section. Given that the length of the target section is Lt, and the sum of the lengths of the portions in which the material of the inner electrode layers 150 is truly present is L1, a ratio L1/Lt is calculated for all of the 10 inner electrode layers 150. An average value thereof is defined as the continuity of this electronic component in the extending portion 302.

For the facing portion 301, the same processing as the extending portion 302 is performed by setting the target section to a section having a length in the length direction L that is 50% of the length of the facing portion 301, and an average value is used as the continuity of this electronic component in the facing portion 301. Thus, the continuity is determined by taking a cross-section along the Length-Lamination (L-T) plane. A measurement line of a predetermined length Lt is established within a target region (e.g., the extending portion or the facing portion). The continuity is defined as L1/Lt where L1 is the sum of the lengths of the conductive electrode material segments along the measurement line.

The continuity in the extending portion 302 is higher than the continuity in the facing portion 301. The continuity in the extending portion 302 is 95% or more. Since the continuity is high in the extending portion 302 as described above, the electrical conductivity is high, and the equivalent series resistance is low. The continuity of the extending portion 302 may be higher than 95%.

The continuity in the facing portion 301 is 85% or more and 95% or less. Since many opening portions are present in the facing portion 301, the adhesion between the dielectric layers 140 is high. As a result, internal peeling is less likely to occur.

### Manufacturing Method

The firing temperature, the firing speed, and the like can be adjusted to change the continuity of the inner electrode layer 150 depending on the portion.

### Shift of End Portions in Width Direction of Inner Electrodes

In the central portion in the length direction L of the multilayer body 101, as viewed in a cross-section including the width direction and the thickness direction, attention is focused on how much the end portions in the width direction W of the inner electrode layers 150 are shifted. The shift widths in the width direction W of the end portions of the inner electrode layers 150 may be 0.5 μm or less. At the end portions in the width direction W of the inner electrode layers 150, a segregation phase of rare-earth elements, such as Mg and Dy, is present. In the extending portion 302, such a segregation phase is thick and short. In the facing portion 301, such a segregation phase is thin and long.

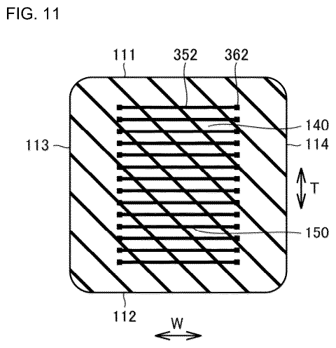

This will be described with reference to FIGS. 9 to 11. A cross-sectional view as viewed along arrows X-X in FIG. 9 is illustrated in FIG. 10. A cross-section view as viewed along arrows XI-XI in FIG. 9 is illustrated in FIG. 11. That is, FIG. 10 illustrates a cross-section in the facing portion 301, and FIG. 11 illustrates a cross-section in the extending portion 302. As illustrated in FIG. 10, segregation phases 361 are generated at both end portions in the width direction W of the inner electrode layers 150 in the facing portion 301. The thickness of the segregation phases 361 is larger than the thickness of central portions 351 in the width direction W of the inner electrode layers 150 in the facing portion 301. As illustrated in FIG. 11, segregation phases 362 are generated at both end portions in the width direction W of the inner electrode layers 150 in the extending portion 302. The segregation phases 362 are thicker and shorter than the segregation phases 361. That is, the dimension of the segregation phases 362 in the width direction W is smaller than the dimension of the segregation phases 361 in the width direction W.

### Operation and Effect

In the embodiment, since the magnitude relationship of continuity between the facing portion and the extending portion is set as described above, the adhesion between the dielectric layers 140 can be enhanced in the facing portion 301 while high electrical conductivity and low equivalent series resistance are achieved in the extending portion 302. In this way, it is possible to achieve a multilayer ceramic capacitor in which interlayer peeling is less likely to occur between the inner electrodes and the dielectric layers.

The thickness of portions of the plurality of inner electrode layers 150 that are present in the extending portion 302 may be at least 1.3 times and at most 1.6 times the thickness of portions of the plurality of inner electrode layers 150 that are present in the facing portion 301. In other words, a thickness ratio between a thickness of an inner electrode layer in the extending portion divided by the thickness of the same inner electrode layer in the facing portion may be between 1.3 and 1.6, inclusive. Since the thickness of the portions of the plurality of inner electrode layers 150 that are present in the extending portion 302 is sufficiently thick in this structure, the continuity of the inner electrode layers 150 in the portions can be easily enhanced.

It should be noted that, when the thicknesses of the portions of the inner electrode layers 150 that are present in the extending portion 302 is determined, the thicknesses of the thickest portions of the inner electrode layers 150 in the extending portion 302 are measured for the upper portion, the central portion, and the lower portion of the multilayer body 101. The average value of these thicknesses is defined as the thickness of the portions of the plurality of inner electrode layers 150 that are present in the extending portion 302.

When the thickness of the portions of the plurality of inner electrode layers 150 that are present in the facing portion 301 is determined, the thicknesses of the inner electrode layers 150 on a total of five lines: the central line in the lamination direction that passes through the center of the cross-section of the multilayer body, two lines drawn at equal intervals on one side of this central line, and two lines drawn at equal intervals on the other side of this central line. The average of these five measurement values is defined as the thickness of the portions of the plurality of inner electrode layers 150 that are present in the facing portion 301.

The continuity of the portions of the plurality of inner electrode layers that are present at the central portion in the length direction of the multilayer body may be higher than the continuity of the portions of the plurality of inner electrode layers that are present near the extending portion.

The continuity of the portions of the plurality of inner electrode layers that are present in the extending portion may be higher than the continuity of any other portion of the plurality of inner electrode layers.

It should be noted that two or more of the embodiments described above may be combined with each other. It should be noted that the embodiments disclosed above are illustrative in all respects and are not restrictive. The scope of the present invention is defined by the claims and includes all modifications within the meaning and the scope equivalent to the claims.

What is claimed is:

1. A multilayer ceramic capacitor comprising:
a ceramic body including a multilayer structure having a plurality of dielectric layers and a plurality of inner electrode layers that are laminated together in a lamination direction,
the ceramic body having a first main surface and a second main surface opposite each other in the lamination direction, a first side surface and a second side surface opposite each other in a width direction orthogonal to the lamination direction, and a first end face and a second end face opposite each other in a length direction orthogonal to the lamination direction and the width direction,
an outer electrode electrically connected to at least one of the plurality of inner electrode layers, the outer electrode being disposed to cover at least a portion of the first end face and at least a portion of the second end face, and
wherein a shift width as viewed in the lamination direction between end portions in the width direction of the plurality of inner electrode layers is 0.5 μm or less,
the ceramic body portion includes
a facing portion in which adjacent inner electrode layers face each other in the lamination direction, and
an extending portion in which portions of the plurality of inner electrode layers extend to the first end face or the second end face, and
wherein a continuity of portions of the plurality of inner electrode in the extending portion is higher than a continuity of portions of the plurality of inner electrode layers in the facing portion.

2. The multilayer ceramic capacitor according to claim 1,
wherein a thickness of the plurality of inner electrode layers in the extending portion are at least 1.3 times and at most 1.6 times a thickness of the plurality of inner electrode layers in the facing portion.

3. The multilayer ceramic capacitor according to claim 1,
wherein the continuity of portions of the plurality of inner electrode layers that are present in a central portion of the multilayer body in the length direction is higher than the continuity of portions of the plurality of inner electrode layers that are present near the extending portion.

4. The multilayer ceramic capacitor according to claim 1,
wherein the continuity of portions of the plurality of inner electrode layers in the extending portion is higher than a continuity of any other portion of the plurality of inner electrode layers.

5. The multilayer ceramic capacitor according to claim 1, wherein the continuity in the extending portion is 95% or more.

6. The multilayer ceramic capacitor according to claim 1, wherein the continuity in the facing portion is 85% or more and 95% or less.

7. The multilayer ceramic capacitor according to claim 1, wherein the inner electrode layers contain Ni as a main component.

8. The multilayer ceramic capacitor according to claim 1, wherein the ceramic body further includes a side margin portion covering the end portions in the width direction of the inner electrode layers.

9. A multilayer ceramic capacitor comprising:
a ceramic body including inner electrode layers and dielectric layers laminated in a lamination direction,
wherein the inner electrode layers include segregation phases of rare-earth elements at end portions in a width direction; and
wherein a dimension of the segregation phases in the width direction within an extending portion of the ceramic body is smaller than a dimension of the segregation phases in the width direction within a facing portion of the ceramic body.

10. The multilayer ceramic capacitor according to claim 9, wherein the rare-earth elements include at least one of Mg and Dy.

11. The multilayer ceramic capacitor according to claim 9, wherein a thickness of the segregation phases in the extending portion is greater than a thickness of the segregation phases in the facing portion.

12. The multilayer ceramic capacitor according to claim 9, wherein a shift width between width-direction end portions of the inner electrode layers is 0.5 μm or less.

13. The multilayer ceramic capacitor according to claim 9, wherein a thickness of the inner electrode layers in the extending portion is at least 1.3 times a thickness of the inner electrode layers in the facing portion.

14. A multilayer ceramic capacitor comprising:
a ceramic body having a facing portion and an extending portion, the ceramic body including a plurality of inner electrode layers laminated with dielectric layers; and
an outer electrode disposed on an end face of the ceramic body and connected to the inner electrode layers at the extending portion, wherein
a thickness of the inner electrode layers in the extending portion is at least 1.3 times a thickness of the inner electrode layers in the facing portion, and
a continuity of the inner electrode layers in the extending portion is 95% or more.

15. The multilayer ceramic capacitor according to claim 14, wherein the continuity in the facing portion is 85% or more and 95% or less.
